(19) United States
(12) Patent Application Publication
(10) Pub. No.: US 2008/0161487 A1
(43) Pub. Date: Jul. 3, 2008

(54) Cosolvent-free, self-crosslinking PU dispersions

(75) Inventors: Sebastian Dorr, Dusseldorf (DE); Heino Muller, Leverkusen (DE); Helmut Muller, Leverkusen (DE); Tanja Hebestreit, Wipperfurth (DE)

Correspondence Address: CONNOLLY BOVE LODGE & HUTZ, LLP, P O BOX 2207, WILMINGTON, DE, 19899, US

(73) Assignee: Bayer MaterialScience AG

(21) Appl. No.: 12/001,830

(22) Filed: Dec. 13, 2007

(30) Foreign Application Priority Data
Dec. 18, 2006 (DE) 102006059680.3

(51) Int. Cl. C09D 175/04; C08G 18/02; C08K 3/20

(52) U.S. Cl. 524/591

(57) ABSTRACT

The present invention relates to a process for preparing self-crosslinking PU dispersions, to the self-crosslinking aqueous dispersions obtainable from this process, to their use as coating compositions, to coating compositions which comprise these self-crosslinking aqueous dispersions, to a method of coating substrates, and to substrates which have been treated with coating compositions which comprise the self-crosslinking aqueous dispersions.

### CROSS-REFERENCE TO RELATED APPLICATION

This application claims priority under 35 U.S.C. § 119(a-d) to German application No. DE 10 2006 059 680.3, filed Dec. 18, 2006.

### FIELD OF THE INVENTION

The present invention relates to a process for preparing self-crosslinking PU dispersions, to the self-crosslinking aqueous dispersions obtainable from this process, to their use as coating compositions, to coating compositions which comprise these self-crosslinking aqueous dispersions, to a method of coating substrates, and to substrates which have been treated with coating compositions which comprise the self-crosslinking aqueous dispersions.

### BACKGROUND OF THE INVENTION

Recent years have seen an increase in the importance of aqueous paints and coating compositions on account of increasingly stringent emissions guidelines governing the solvents released in the course of application of coating materials. Although there are now aqueous coating systems available for many fields of application, these systems often still contain considerable quantities of cosolvents, usually from the preparation process. In particular there have still to date not been any disclosures of polyurethane-based coating compositions with low cosolvent content that can be processed from the aqueous phase and that adequately satisfy the exacting requirements of the art in the context of automotive OEM finishing.

Recent years have seen further improvements achieved in the sector of one-component (1K) baking varnishes. Application EP-A 1 311 571 describes self-crosslinking polyurethane dispersions obtained from a physical mixture of polyols containing urethane groups and hydroxyl groups and of non-hydrophilicized polyisocyanates blocked to an extent of at least 50 equivalent percent with dimethylpyrazole derivatives. These physical mixtures of polyol components and blocked polyisocyanates feature significant advantages from the coatings standpoint but are subject to considerable disadvantages with regard to their preparation. On the one hand, in the application described, the blocked polyisocyanate component is prepared in a separate reaction vessel, implying a considerable extra effort as compared with a process which is carried out in one vessel. On the other hand, owing to the considerable viscosity of the blocked polyisocyanate on its own, the practitioner is required to add solvents, since otherwise metering is not possible. On safety grounds, solutions of this kind in highly volatile solvents such as acetone, for example, cannot be stored or transported, with the consequence that only solvents of low volatility can be used for the blocked polyisocyanates. These solvents inevitably remain in the dispersion and in the coating formulations, and are released only at the premises of the user, which is generally undesirable. The self-crosslinking baking systems described in EP-A 1 311 571 contain between 4.8% and 11.3% by weight of cosolvents, relative to the dispersion, which is too much for certain fields of application of water-based coating systems.

A further disadvantage of the process described in EP-A 1 311 571 is that the blocked polyisocyanates cannot automatically be stably dissolved in a solvent. Certain blocking agents, therefore, cannot be employed.

### SUMMARY OF THE INVENTION

It is an object of the present invention, accordingly, to provide a self-crosslinking aqueous polyurethane dispersion which contains no cosolvent or only very small quantities of cosolvent, so that there cannot be any evaporation of the cosolvent at the premises of the end user.

This object is achieved by means of a process for preparing self-crosslinking aqueous polyurethane dispersions, comprising the following steps:
I. reacting a
   a1) polyisocyanate
      with a mixture of
   a2) anionic hydrophilicizing agent containing at least one isocyanate-reactive group and having an average OH functionality of ≧1 and
   a3) at least one polyol component having an average OH functionality of >1,
   either the mixture of a2) and a3) or component a1) comprising
   k) at least one catalyst,
II. obtaining an OH-functional and NCO-free polyurethane from step I, the polyurethane subsequently being mixed with
III. a4) a reactive blocking agent for isocyanate groups,
IV. subsequently reacting this mixture from step III with
   a5) one or more polyisocyanates being identical to or different from the polyisocyanate used in a1), and subsequently
V. obtaining a physical mixture of OH-functional, NCO-free polyurethane and blocked polyisocyanate from step IV, wherein subsequently either
VI. the acid groups of the OH-functional polyurethane are subjected to total or partial deprotonation by addition of
   a6) a neutralizing agent
VII. and the polyurethane obtained from this step VI is dispersed in water
   or step VII takes place before step VI.

The process of the invention is advantageous if step VI takes place before or after step VII.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

The process of the invention is advantageous if the blocking agents used in step III are compounds selected from the group consisting of butanone oxime, diisopropylamine and 3,5-dimethylpyrazole.

The process of the invention is advantageous if up to 30% by weight, based on the polyurethane from step II, of a solvent or solvent mixture selected from the group consisting of acetone, methyl ethyl ketone and tetrahydrofuran and mixtures thereof is used after step II or step III, and is subsequently removed by distillation after step VII.

The invention further provides self-crosslinking aqueous polyurethane dispersion obtainable by the process of the invention.

The invention further provides for the use of the self-crosslinking aqueous polyurethane dispersion of the invention for preparing coating compositions.

The invention further provides coating compositions which comprise the self-crosslinking aqueous polyurethane dispersion of the invention.

The coating composition of the invention is advantageous if it is selected from the group consisting of inks, paints and adhesives.

Further provided by the present invention is a method of coating substrates using the coating compositions of the invention.

The coating method of the invention is advantageous if motor vehicle bodies or parts of motor vehicle bodies are coated with the coating composition of the invention.

The invention further provides a substrate comprising a coating which comprises the coating composition of the invention.

The article of the invention is advantageous if it is a complete motor vehicle body or part of a motor vehicle body.

In the dispersion of the invention the ratio of the resulting isocyanate groups blocked with a4) to the isocyanate-reactive OH groups is from 0.2 to 5.0:1, preferably 0.4 to 2.0:1, more preferably 0.5 to 1.5:1.

The amounts of the individual components are calculated so as to result in the following weight proportions of components a1) to a6):

a1): 3 to 25, preferably 6 to 18, more preferably 7 to 14 parts by weight;
a2): 0.3 to 8, preferably 1 to 6, more preferably 2 to 5 parts by weight;
a3): 40 to 85, preferably 50 to 75, more preferably 60 to 70 parts by weight;
a4): 1 to 20, preferably 3 to 17, more preferably 4 to 10 parts by weight;
a5): 3 to 25, preferably 5 to 20, more preferably 9 to 17 parts by weight;
a6) 0.5 to 10, preferably 1 to 6, more preferably 2 to 4 parts by weight;
k): 0.001 to 2, preferably 0.005 to 0.1, more preferably 0.01 to 0.08 parts by weight.

The stated parts by weight relate to the specified components, without the water fraction or any solvents present.

The amount of neutralizing agent a6) used is generally such that the degree of neutralization of the carboxylic and/or sulphonic acid groups present in the polyurethane from step II (molar ratio of amine employed to acid groups present) is at least 50%, preferably 80% to 120%, more preferably 95% to 105%. The neutralization can take place before, during or after the dispersing step VII or dissolving step. Preference, however, is given to neutralization prior to the addition of water before step VII).

In component a1) it is possible to use all organic compounds containing isocyanate groups, but preferably aliphatic, cycloaliphatic, aromatic or heterocyclic polyisocyanates with an NCO functionality ≧2, individually or in any desired mixtures with one another, irrespective of whether they have been prepared by phosgenation or by phosgene-free processes.

Examples of such isocyanates are tetramethylene diisocyanate, cyclohexane 1,3- and 1,4-diisocyanate, hexamethylenediisocyanate (HDI), 1-isocyanato-3,3,5-trimethyl-5-isocyanatomethylcyclohexane (isophorone diisocyanate, IPDI), methylenebis(4-isocyanatocyclohexane), tetramethylxylylene diisocyanate (TMXDI), triisocyanatononane, tolylene diisocyanate (TDI), diphenylmethane 2,4′- and/or 4,4′-diisocyanate (MDI), triphenylmethane 4,4′-diisocyanate or naphthylene 1,5-diisocyanate, and any desired mixtures of such isocyanates.

Likewise highly suitable are the polyisocyanates derived from these and having a uretdione, carbodiimide, isocyanurate, iminooxadiazinedione, biuret, urethane, allophanate, oxadiazinetrione or acylurea structure and also polyisocyanate prepolymers with an average NCO functionality >1, of the kind obtained by preliminary reaction of a molar excess of one of the abovementioned polyisocyanates with an organic material that has at least two isocyanate-reactive hydrogen atoms per molecule, in the form of OH groups, for example.

In a1) it is preferred to use compounds of the aforementioned kind having a molecular weight of 140 to 1000 g/mol.

It is particularly preferred in component a1) to use polyisocyanates or polyisocyanate mixtures of the stated kind containing exclusively aliphatically and/or cycloaliphatically attached isocyanate groups, in particular those based on hexamethylene diisocyanate (HDI), isophorone diisocyanate (IPDI) and/or 4,4′-diisocyanatodicyclohexylmethane.

The polyol component a2) preferably has an average OH functionality of 1 to 6, more preferably of 2 to 4, and a number-average molecular weight of 62 to 2500 g/mol, preferably 62 to 1000 g/mol, more preferably 62 to 500 g/mol, and contains an acid-functional compound which in addition to the acid function also contains at least one isocyanate-reactive OH group.

These compounds are preferably carboxylic acids containing at least one, preferably one or two, hydroxyl groups, or are salts of such hydroxycarboxylic acids. Suitable such acids are, for example, 2,2-bis(hydroxymethyl)alkanecarboxylic acids such as dimethylolacetic acid, 2,2-dimethylolpropionic acid, 2,2-dimethylolbutyric acid or 2,2-dimethylolpentanoic acid, dihydroxysuccinic acid, hydroxypivalic acid or mixtures of such acids.

As component a5) it is preferred to use dimethylolpropionic acid and/or hydroxypivalic acid.

With particular preference a2) contains exclusively aforementioned acid-functional compounds of this kind, and with very particular preference dimethylpropionic acid is used exclusively as a2).

The polyol component used in a3) is composed of
b1) dihydric to hexahydric alcohols having number-average molecular weights of 62 to 300 g/mol, preferably 62 to 182 g/mol, more preferably 62 to 118 g/mol
b2) polyols having an OH functionality ≧2 and having number-average molecular weights of 300 to 5000 g/mol, preferably 300 to 3000 g/mol, more preferably 300 to 2000 g/mol and/or
b3) monofunctional linear polyethers having number-average molecular weights of 300 to 3000 g/mol, preferably 300 to 2000 g/mol, more preferably 300 to 1000 g/mol.

Suitable polyols b1) are dihydric to hexahydric alcohols and/or mixtures thereof that contain no ester groups. Typical examples are ethane-1,2-diol, propane-1,2-diol and -1,3-diol, butane-1,4-diol, -1,2-diol or -2,3-diol, hexane-1,6-diol, 1,4-dihydroxycyclohexane, glycerol, trimethylolethane, trimethylolpropane, pentaerythritol and sorbitol.

Preferred compounds for b1) are 1,4- or 1,3-butanediol, 1,6-hexanediol and/or trimethylolpropane.

Suitable polyols of component b2) are selected from the group consisting of polyethers, polyesters and/or polycarbonates. Preferably b2) comprises at least one polyol that contains ester groups and has a number-average molecular weight of 350 to 4000 g/mol, preferably 350 to 2000 g/mol, more preferably 350 to 1000 g/mol. The preferred average OH functionality is 2 to 40H groups per molecule.

Polyols of this kind containing ester groups are the polyesterpolyols known per se which have been synthesized from low molecular weight polyols and dicarboxylic acids. Examples of suitable low molecular weight polyols for this purpose are 1,4-butanediol, 1,3-butanediol, 1,6-hexanediol, 2,2,4-trimethyl-1,3-pentanediol, trimethylolpropane, pentaerythritol or sorbitol. Examples of suitable dicarboxylic acids are aromatic dicarboxylic acids such as phthalic acid, isophthalic acid and terephthalic acid; cycloaliphatic dicarboxylic acids such as hexahydrophthalic acid, tetrahydrophthalic acid, endomethylenetetrahydrophthalic acid and/or their anhydrides; and aliphatic dicarboxylic acids, such as succinic acid, glutaric acid, adipic acid, suberic acid, azelaic acid, sebacic acid and/or their anhydrides. Aliphatic dicarboxylic acids are used preferably to synthesize the esterdiols.

As polyesterpolyols in component b2) it is preferred to use polycaprolactonediols having a number-average molecular weight of 350 to 4000 g/mol, preferably 350 to 2000 g/mol, more preferably 350 to 1000 g/mol. These diols are obtainable in conventional manner from a diol, triol or diol/triol mixture of the kind exemplified above, as a starter, and from s-caprolactone.

Preferred polycaprolactonediols are prepared by polymerizing s-caprolactone using 1,6-hexanediol as the starter.

Particularly preferred polyesterpolyols are those based on adipic acid, phthalic acid, isophthalic acid and tetrahydrophthalic acid as the acid component and on 1,4- or 1,3-butanediol, 1,6-hexanediol and/or trimethylolpropane as the alcohol component.

In component b2) it is also possible to use (co)polyethers of ethylene oxide, propylene oxide and/or tetrahydrofuran. Preferred polyethers are those having a number-average molecular weight of 500 to 2000 g/mol, such as polyethylene oxides or polytetrahydrofurandiols.

In addition it is also possible for b2) to include hydroxyl-containing polycarbonates such as hexanediol polycarbonate or polyestercarbonates, with a preferred number-average molecular weight of 400 to 4000 g/mol, more preferably 400 to 2000 g/mol.

Suitable monofunctional linear polyethers of component b3) are, for example, (co)polyethers of ethylene oxide and/or propylene oxide. Preference is given to polyalkylene oxide polyethers prepared starting from monoalcohol and having a number-average molecular weight of 350 to 2500 g/mol with at least 70% ethylene oxide units. Particularly preferred (co)polymers are those with more than 75% ethylene oxide units and a number-average molecular weight of 300 to 2500 g/mol, preferably 500 to 1000 g/mol. Starter molecules used in preparing these polyethers are preferably monofunctional alcohols having 1 to 6 carbon atoms.

The blocking agents used in a4) are selected from conventional blocking agents for isocyanate groups; the blocking agents used must have a higher reactivity with isocyanate groups than that of the OH groups of the polyurethane polymer. Examples of suitable blocking agents are oximes such as butanone oxime, amines such as diisopropylamine, or tert-butylbenzylamine, 3,5-dimethylpyrazole, triazole or mixtures thereof. Preference is given to butanone oxime, diisopropylamine, 3,5-dimethylpyrazole or mixtures thereof.

The reactivity of the blocking agents with isocyanate groups is easy for the person skilled in the art to determine and relates to a temperature range between 0 and 100° C., preferably between 20 and 60° C. The reactivity can be increased by means of catalysts known to the person skilled in the art; by means of such catalysts it is also possible for the reactivity of the blocking agent to be deliberately increased more highly than the reactivity of the alcohol groups of the polyol.

The polyisocyanate component used as a5) may be composed of the same units listed under component a1). The components a1) and a5) may be alike or different. Preferred for a5) are polyisocyanate components and/or mixtures thereof having an isocyanate functionality in the range from 2 to 6, more preferably from 2.5 to 5 and very preferably from 3 to 4.5.

Examples of neutralizing agents used as a6) are triethylamine, dimethylaminoethanol, dimethylcyclohexylamine, triethanolamine, methyldiethanolamine, diisopropanolamine, ethyldiisopropylamine, diisopropylcyclohexylamine, N-methylmorpholine, 2-amino-2-methyl-1-propanol, ammonia, hydroxides such as sodium hydroxide or any desired mixtures of these. Preferred neutralizing agents are tertiary amines such as triethylamine, diisopropylhexylamine and dimethylethanolamine, with dimethylethanolamine being particularly preferred.

In one preferred embodiment of the process of the invention the isocyanate-reactive components a2) and a3) and the catalyst k) are introduced to start with and then the polyisocyanate a1) of step I of the process of the invention is added. The temperature range in this case is set preferably between 50° C. and 140° C. The catalyst k) may be admixed with each of components a1), a2), or a3), or may be added separately. The reaction according to step I can be carried out in non-isocyanate-reactive solvents, so-called cosolvents, preference being given to carrying out this reaction step I without cosolvents. After components k), a1), a2) and a3) have been mixed according to step I, stirring is continued until NCO groups are no longer detectable by IR spectroscopy.

Subsequently, in one preferred version, the resulting OH-functional and NCO-free polyurethane of step II is dissolved in a volatile, water-miscible cosolvent having a boiling point below 85° C. under a pressure of 1013 mbar, such as acetone, for example, and the solution is then mixed with the blocking agent a4). Alternatively, first of all the blocking agent can be mixed into the polyurethane from step II of the process of the invention, and then the resulting mixture can be dissolved in the solvent. The preferred solvent content of the mixture from step II is dependent on its viscosity and is between 0% and 60% by weight, with particular preference between 5% and 30% by weight. A temperature is set of between 0° C. and 80°, preferably between 20 and 50° C. Subsequently the polyisocyanate component a5) is metered in at a rate such that the temperature does not exceed 80° C. It is preferred to maintain a temperature range between 20 and 60° C. during the addition and during the subsequent stirring. The mixture is stirred until NCO groups are no longer detectable by IR spectroscopy.

In the preferred embodiment the acid groups of the polyurethane from the unit a2) are subsequently subjected to complete or partial deprotonation with a base a6), after which dispersing takes place with water.

For the dispersing in water, the polyurethane solution is either introduced into the dispersing water, where appropriate with strong shearing, generally with a stirring energy of 1 W/l to 1000 kW/l, or, conversely, the dispersing water is stirred into the polyurethane solutions. Preferably the water is added to the dissolved polyurethane. After the end of dispersing in step VII, any volatile solvent present is removed by distillation, The distillation takes place preferably under reduced pressure at temperatures between 20 and 70° C., more preferably at 30 to 50° C. The reduced pressure is set preferably at between 50 and 500 mbar, more preferably between 100 and 200 mbar. It is possible first to set the desired temperature and to adapt the reduced pressure necessary for distillation, or vice versa. In one especially preferred procedure a reduced pressure of between 100 and 200 mbar is set first of all and then the dispersion is warmed from room temperature to 40° C. The advantage of this procedure lies in the small fraction of the solvent in the completed dispersion, which is generally below 0.5% by weight relative to the dispersion.

A further possibility, though not a preferred one, is to add further cosolvents which cannot be removed by distillation. These cosolvents are used in such a way that their amount relative to the dispersion is up to 4% by weight, preferably up to 2% by weight relative to the dispersion. Particular preference is given to preparing cosolvent-free dispersions.

Reaction step I is accelerated using at least one catalyst k) selected from the group consisting of tertiary amines, tin compounds, zinc compounds or bismuth compounds, particular preference being given to triethylamine, 1,4-diazabicyclo[2.2.2]octane, tin dioctoate and dibutyltin dilaurate. Very particular preference is given to tin dioctoate and dibutyltin dilaurate. This polyurethane catalyst k) accelerates the formation of urethane in step II. In EP-A 2006/005878 as well the abovementioned catalysts are employed. Here, however, they are used as blocking catalysts in a later step of the process.

The self-crosslinking aqueous dispersions obtainable in this way in accordance with the invention have solids contents of 10% to 70% by weight, preferably 30% to 55% by weight, of non-volatile constituents relative to the dispersion, as determined by drying a film at 100° C. to constant weight.

The dispersions obtainable by the process of the invention can be used as one-component baking systems containing free hydroxyl groups for producing paints, inks and other formulations. In this context it is possible as well to use the auxiliaries and additives that are typical in coatings technology, such as pigments, flow control agents, bubble-preventing additives or catalysts. Also possible is a mixture with other alcohol-reactive compounds such as amino crosslinker resins, for example, such as melamine resins and/or urea resins, for the purpose of additional crosslinking on baking.

The invention also provides for the use of the self-crosslinking aqueous dispersions of the invention for producing inks, paints or adhesives, more particularly for automotive OEM finishing and also for can and coil coating.

These aqueous one-component coating compositions comprising the self-crosslinking aqueous dispersions of the invention can be applied in one or more coats by all desired methods of coating technology, such as spraying, spreading, dipping, flowcoating, or using rollers and doctor blades, to any desired heat-resistant substrates. The coating films generally have a dry film thickness of 0.001 to 0.3 mm.

Examples of suitable substrates are metal, plastic, wood or glass. Curing of the coating film takes place at 80 to 260° C., preferably at 130 to 240° C.

The aqueous one-component coating compositions are preferentially suitable for the production of coatings and finishes on steel sheets, of the kind used, for example, to produce vehicle bodies, machines, casings, drums or containers. Particular preference is given to their use for the production of automotive surfacers and/or topcoat materials.

### EXAMPLES

### Desmodur® N 3300

Isocyanurate based on hexamethylene diisocyanate, Bayer MaterialScience AG, Leverkusen, Germany

The other chemicals were acquired from the specialist chemicals trade (Sigma-Aldrich Chemie GmbH, Taufkirchen, Germany).

Unless noted otherwise, all percentages are by weight.

Unless noted otherwise, all analytical measurements relate to temperatures of 23° C.

The reported viscosities were determined by measure of rotational viscometer in accordance with DIN 53019 at 23° C., using a rotational viscometer from Anton Paar Germany GmbH, Ostfildern, Germany.

Unless expressly mentioned otherwise, NCO contents were determined volumetrically in accordance with DIN-EN ISO 11909.

The reported particle sizes were determined by means of laser correlation spectroscopy (Instrument: Malvern Zetasizer 1000, Malvern Inst. Limited).

The solids contents were determined by heating a weighed sample at 100° C. At constant weight, weighing of the sample was repeated and the solids content calculated therefrom.

The check for free NCO groups was carried out by means of IR spectroscopy (band at 2260 cm⁻¹).

### Example B1

### Reworking of EP-A 1311571 B1 (DMP-Blocked N 3300 in MPA/SN100)

In accordance with experiment B1 in EP-A 1311571, 625 g of Desmodur® N 3300, 104 g of 1-methoxypropyl acetate and 209 g of Solventnaphtha® 100 (Shell) were heated to 50° C. 314 g of 3,5-dimethylpyrazole were added to the solution at a rate such that the temperature does not exceed 65° C. Stirring was then continued at 50° C. until isocyanate groups were no longer detectable (approximately an hour). The viscosity of the solution was 3910 mPas (23° C., shear rate 186 s⁻¹).

### Example B2

### (Analogous to 1) DMP-blocked N 3300 without Solvents)

625 g of Desmodur® N 3300 were heated to 50° C. in a stirred apparatus. Then 314 g of 3,5-dimethylpyrazole were added at a rate such that the temperature does not exceed 65° C. Stirring was then continued at 65° C. until isocyanate groups were no longer detectable by IR spectroscopy (approximately an hour). The mixture rapidly became very viscous. On cooling to room temperature, there was no fluidity present, and even after heating to 50° C. it was not possible to discharge the product.

This blocked polyisocyanate is not suitable for preparing a self-crosslinking polyurethane dispersion, since metering is not a possibility. Consequently, the preparation of a corresponding cosolvent-free dispersion in the obvious way from the prior art is not possible simply by doing without cosolvent.

### Example B3

### Experiment on the Introduction of Diisopropylamine as a Blocking

Agent in Accordance with Process B1 in EP 1311571 B1

The procedure described in Example 1) was repeated, but 324.3 g of diisopropylamine were added instead of 314 g of 3,5-dimethylpyrazole.

The viscosity of the solution directly after preparation was 49 300 mPas (23° C., shear rate 186 s⁻¹). Over the course of a few days, crystals formed in the vessel, and fluidity was no longer present.

As a result of the high viscosity and the crystallization tendency it is not possible to prepare a self-crosslinking polyurethane dispersion with diisopropylamine-blocked isocyanate groups in analogy to the dimethylpyrazole-blocked systems in EP-A 1311571.

### Example D1

### Not Inventive, Reworking of a Dispersion Corresponding to EP-A 1311571 D7

A 2 litre stirred apparatus was charged with 234.8 g of a polyester having an OH content of 3.3% and an acid number of about 3 mg KOH/g, consisting of 39.7% of neopentyl glycol, 6.4% of trimethylpropane, 43.5% of tetrahydrophthalic anhydride and 10.4% of adipic acid and also with 234.8 g of a polyester having an OH content of 2.0% and an acid number of about 1 mg KOH/g, composed of 30.4% of hexane-1,6-diol, 16.9% of neopentyl glycol and 52.7% of adipic acid, and this polyester mixture, together with 31.5 g of dimethylolpropionic acid, 28.95 g of trimethylolpropane, 69.86 g of N-methylpyrrolidone and 0.80 g of tin octoate was heated to 130° C. and homogenized with stirring for 30 minutes. The batch was then cooled to 90° C. and 99.4 g of isophorone diisocyanate (IPDI) were added with vigorous stirring. Immediately thereafter the mixture was heated to 130° C. and held at that temperature until isocyanate groups were no longer detectable by IR spectroscopy.

The mixture was then cooled to 70° C. and admixed with 200.2 g of the solution of the blocked polyisocyanate from Example B1). After 30 minutes 20.9 g of N,N-dimethylethanolamine were added, the mixture was stirred at 70° C. for 10 minutes more, and then 665 g of deionized water were added.

The properties of the dispersion were as follows:

| | |
|---|---|
| Solids content | 49.6% |
| pH | 7.7 |
| Viscosity mPas (23° C., shear rate 186 s⁻¹) | 343 mPas |
| Particle size (laser correlation spectroscopy, LCS) | 73 nm |

### Example D2

### Not Inventive, Based on Example D1, DMP-Blocked, Cosolvent-Free Self-Crosslinker Dispersion, Blocking In Situ with Catalysis of the Blocking Step, as Described in EP-A 2006/005878

A 2 litre stirred apparatus was charged with 234.8 g of a polyester having an OH content of 3.3% and an acid number of about 3 mg KOH/g, consisting of 39.7% of neopentyl glycol, 6.4% of trimethylolpropane, 43.5% of tetrahydrophthalic anhydride and 10.4% of adipic acid and also with 234.8 g of a polyester having an OH content of 2.0% and an acid number of about 1 mg KOH/g, composed of 30.4% of hexane-1,6-diol, 16.9% of neopentyl glycol and 52.7% of adipic acid, and this polyester mixture, together with 31.5 g of dimethylolpropionic acid and 28.95 g of trimethylolpropane was heated to 130° C. and homogenized with stirring for 30 minutes. The batch was ten cooled to 90° C. and 99.4 g of isophorone diisocyanate (IPDI) were added with vigorous stirring. Immediately thereafter the mixture was heated to 130° C. and held at that temperature until isocyanate groups were no longer detectable by IR spectroscopy.

The mixture was then cooled to 70° C., after which 140 g of acetone were added and cooling took place to 40° C. At 40° 50.5 g of 3,5-dimethylpyrazole and 0.8 g of tin dioctoate were added, followed by 20 minutes of stirring, after which 102.4 g of Desmodur® N 3300 were metered in over the course of an hour, at which point the temperature was between 35 and 40° C. Stirring was continued for an hour until isocyanate groups were no longer detectable by IR spectroscopy. Then 20.9 g of N,N-dimethylethanolamine were added, stirring was continued at 40° C. for 10 minutes, and then 789 g of deionized water were added, A dispersion was not formed; instead, a coarse-particled sediment was deposited immediately. Further dilution with 363 g of water also did not result in dispersion.

### Example D3

### Inventive, Like Example D2, DMP-Blocked, Cosolvent-Free Self-Crosslinker Dispersion, But Preparation with Addition of the Catalyst Prior to the Formation of the OH-Containing Polyurethane

A 2 litre stirred apparatus was charged with 234.8 g of a polyester having an OH content of 3.3% and an acid number of about 3 mg KOH/g, consisting of 39.7% of neopentyl glycol, 6.4% of trimethylolpropane, 43.5% of tetrahydrophthalic anhydride and 10.4% of adipic acid and also with 234.8 g of a polyester having an OH content of 2.0% and an acid number of about 1 mg KOH/g, composed of 30.4% of hexane-1,6-diol, 16.9% of neopentyl glycol and 52.7% of adipic acid, and this polyester mixture, together with 31.5 g of dimethylolpropionic acid, 28.95 g of trimethylolpropane and 0.8 g of tin dioctoate was heated to 130° C. and homogenized with stirring for 30 minutes. The batch was then cooled to 90° C. and 99.4 g of isophorone diisocyanate (IPDI) were added with vigorous stirring. Immediately thereafter the mixture was heated to 130° C. and held at that temperature until isocyanate groups were no longer detectable by IR spectroscopy.

The mixture was then cooled to 70° C., after which 140 g of acetone were added and cooling took place to 40° C. At 40° 50.5 g of 3,5-dimethylpyrazole were added, followed by 20 minutes of stirring, after which 102.4 g of Desmodur® N 3300 were metered in over the course of an hour, at which point the temperature was between 35 and 40° C. Stirring was continued for an hour until isocyanate groups were no longer detectable by IR spectroscopy. Then 20.9 g of N,N-dimethylethanolamine were added, stirring was continued at 40° C. for 10 minutes, and then 789 g of deionized water were added. A fine-particle dispersion was formed, from which the acetone was removed by distillation at 40° C. under reduced pressure (120 mbar) over approximately 2 hours.

The properties of the dispersion were as follows:

| | |
|---|---|
| Solids content | 49.0% |
| pH | 8.0 |
| Viscosity mPas (23° C., shear rate 186 s⁻¹) | 977 mPas |
| Particle size (laser correlation spectroscopy, LCS) | 103 nm |

### Example D4

### Inventive, Like Example D3 But with Different Blocking Agent: Butanone Oxime-Blocked, Cosolvent-Free Self-Crosslinker Dispersion

A 2 litre stirred apparatus was charged with 234.8 g of a polyester having an OH content of 3.3% and an acid number of about 3 mg KOH/g, consisting of 39.7% of neopentyl glycol, 6.4% of trimethylolpropane, 43.5% of tetrahydrophthalic anhydride and 10.4% of adipic acid and also with 234.8 g of a polyester having an OH content of 2.0% and an acid number of about 1 mg KOH/g, composed of 30.4% of hexane-1,6-diol, 16.9% of neopentyl glycol and 52.7% of adipic acid, and this polyester mixture, together with 31.5 g of dimethylolpropionic acid, 28.95 g of trimethylolpropane and 0.8 g of tin dioctoate was heated to 130° C. and homogenized with stirring for 30 minutes. The batch was then cooled to 90° C. and 99.4 g of isophorone diisocyanate (IPDI) were added with vigorous stirring. Immediately thereafter the mixture was heated to 130° C. and held at that temperature until isocyanate groups were no longer detectable by IR spectroscopy.

The mixture was then cooled to 70° C., after which 140 g of acetone were added and cooling took place to 40° C. At 40° 45.7 g of butanone oxime were added, followed by 20 minutes of stirring, after which 102.4 g of Desmodur® N 3300 were metered in over the course of an hour, at which point the temperature was between 35 and 40° C. Stirring was continued for an hour until isocyanate groups were no longer detectable by IR spectroscopy. Then 20.9 g of N,N-dimethylethanolamine were added, stirring was continued at 40° C. for 10 minutes, and then 975 g of deionized water were added. A fine-particle dispersion was formed, from which the acetone was removed by distillation at 40° C. under reduced pressure (120 mbar) over approximately 2 hours.

The properties of the dispersion were as follows:

| | |
|---|---|
| Solids content | 43.9% |
| pH | 8.1 |
| Viscosity mPas (23° C., shear rate 186 s⁻¹) | 387 mPas |
| Particle size (laser correlation spectroscopy, LCS) | 111 nm |

### Example D5

### Inventive, Like Example D3 But with Different Blocking Agent: Diisopropylamine-Blocked, Cosolvent-Free Self-Crosslinker Dispersion

A 2 litre stirred apparatus was charged with 234.8 g of a polyester having an OH content of 3.3% and an acid number of about 3 mg KOH/g, consisting of 39.7% of neopentyl glycol, 6.4% of trimethylpropane, 43.5% of tetrahydrophthalic anhydride and 10.4% of adipic acid and also with 234.8 g of a polyester having an OH content of 2.0% and an acid number of about 1 mg KOH/g, composed of 30.4% of hexane-1,6-diol, 16.9% of neopentyl glycol and 52.7% of adipic acid, and this polyester mixture, together with 31.5 g of dimethylolpropionic acid, 28.95 g of trimethylolpropane and 0.8 g of tin dioctoate was heated to 130° C. and homogenized with stirring for 30 minutes. The batch was then cooled to 90° C. and 99.4 g of isophorone diisocyanate (IPDI) were added with vigorous stirring. Immediately thereafter the mixture was heated to 130° C. and held at that temperature until isocyanate groups were no longer detectable by IR spectroscopy.

The mixture was then cooled to 70° C., after which 140 g of acetone were added and cooling took place to 40° C. At 40° 45.7 g of butanone oxime were added, followed by 20 minutes of stirring, after which 102.4 g of Desmodur® N 3300 were metered in over the course of an hour, at which point the temperature was between 35 and 40° C. Stirring was continued for an hour until isocyanate groups were no longer detectable by IR spectroscopy. Then 20.9 g of N,N-dimethylethanolamine were added, stirring was continued at 40° C. for 10 minutes, and then 975 g of deionized water were added. A fine-particle dispersion was formed, from which the acetone was removed by distillation at 40° C. under reduced pressure (120 mbar) over approximately 2 hours.

The properties of the dispersion were as follows:

| | |
|---|---|
| Solids content | 48.9% |
| pH | 8.2 |
| Viscosity mPas (23° C., shear rate 186 s⁻¹) | 1650 mPas |
| Particle size (laser correlation spectroscopy, LCS) | 113 nm |

The performance properties of the dispersions of the invention are evident from Table 1.

Clearcoat materials with the composition below were prepared. From the clearcoat materials, films were produced, dried at room temperature for 10 minutes and then baked at 140° C. or 160° C. for 30 minutes. The films obtained were assessed for their performance.

The pendulum hardnesses were measured by the method of König in accordance with DIN 53157.

The solvent fastnesses were assessed after 1 minute of exposure time to each of the following solvents in this order: xylene/methoxypropyl acetate/ethyl acetate/acetone; assessment: 0, very good, to 5, poor.

TABLE 1

| | Dispersion from Example No. | | | |
|---|---|---|---|---|
| | D1 | | | |
| | (Comparative) | D3 | D4 | D5 |
| Initial product masses of | 150.0 | 150.0 | 150.0 | 150.0 |
| dispersion [g] | | | | |
| Additol XW 395 [g] | 1.2 | 1.2 | 1.2 | 1.2 |
| N,N- | 1.8 | 0.7 | — | — |
| Dimethylethanolamine, | | | | |
| 10% in water [g] | | | | |
| Distilled water [g] | 12.0 | 17.0 | 5.0 | 15.0 |
| Total [g] | 165.0 | 168.9 | 156.2 | 166.2 |
| Solids [%] | 45.1 | 43.5 | 42.2 | 44.1 |
| pH | 8.3 | 8.3 | 8.3 | 8.3 |
| Flow time ISO cup | 37 | 41 | 30 | 40 |
| 5 mm [s] | | | | |
| Baking conditions: | | | | |
| 10 min. RT + 30 min. | | | | |
| 140° C. | | | | |
| Pendulum hardness [s] | 21 | 20 | 14 | 18 |
| Solvent fastness | 4444 | 4444 | 4444 | 4444 |
| 1 min. (0-5) | | | | |
| Film appearance⁽¹⁾ | OK | OK | OK | OK |
| Baking conditions: | | | | |
| 10 min. RT + 30 min. | | | | |
| 160° C. | | | | |
| Pendulum hardness [s] | 21 | 20 | 18 | 16 |
| Solvent fastness | 4444 | 4444 | 4444 | 4444 |
| 1 min. (0-5) | | | | |
| Film appearance⁽¹⁾ | OK | OK | OK | OK |

⁽¹⁾OK = satisfactory, no defects

The dispersions prepared by the process of the invention exhibit the desired requirements in terms of film formation, and the figures for the solvent fastnesses and pendulum hardnesses of the cured films are satisfactory. Disadvantages as compared with the solvent-containing comparative example from D1 are not present in the case of the dispersions of the invention.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Process for preparing self-crosslinking aqueous polyurethane dispersions, comprising the following steps:
I. reacting a
a1) polyisocyanate
with a mixture of
a2) anionic hydrophilicizing agent containing at least one isocyanate-reactive group and having an average OH functionality of ≧1 and
a3) at least one polyol component having an average OH functionality of >1,
either the mixture of a2) and a3) or component a1) comprising
k) at least one catalyst,
II. obtaining an OH-functional and NCO-free polyurethane from step I, the polyurethane subsequently being mixed with
III. a4) a reactive blocking agent for isocyanate groups,
IV. subsequently reacting this mixture from step III with
a5) one or more polyisocyanates being identical to or different from the polyisocyanate used in a1), and subsequently
V. obtaining a physical mixture of OH-functional, NCO-free polyurethane and blocked polyisocyanate from step IV, wherein subsequently either
VI. the acid groups of the OH-functional polyurethane are subjected to total or partial deprotonation by addition of
a6) a neutralizing agent
VII. and the polyurethane obtained from this step VI is dispersed in water
or step VII takes place before step VI.

2. Process according to claim 1, step VI taking place before step VII.

3. Process according to claim 1, step VII taking place before step VI.

4. Process according to claim 1, wherein the blocking agents used in step III are compounds selected from the group consisting of butanone oxime, diisopropylamine and 3,5-dimethylpyrazole.

5. Process according to claim 1, wherein up to 30% by weight, based on the polyurethane from step II, of a solvent or solvent mixture selected from the group consisting of acetone, methyl ethyl ketone and tetrahydrofuran and mixtures thereof is used after step II or step III, and is subsequently removed by distillation after step VII.

6. Self-crosslinking aqueous polyurethane dispersion obtained by the process according to claim 1.

7. Coating compositions comprising the self-crosslinking aqueous polyurethane dispersion according to claim 6.

8. Coating compositions according to claim 7, selected from the group consisting of inks, paints and adhesives.

9. Method of coating substrates, comprising the step of coating a substrate using coating compositions according to claim 7.

10. Method according to claim 9, wherein motor vehicle bodies or parts of motor vehicle bodies are coated with a coating composition according to claim 7.

11. Substrate comprising a coating composition according to claim 7.

12. Substrate according to claim 11, the substrate being a complete motor vehicle body or part of a motor vehicle body.
